(19) United States
(12) Patent Application Publication
(10) Pub. No.: US 2014/0327262 A1
(43) Pub. Date: Nov. 6, 2014

(54) QUICK CONNECT OMNI-POSITIONAL HOIST RING ASSEMBLY

(71) Applicant: MJT Holdings, LLC, Valdosta, GA (US)

(72) Inventor: Tony J. Alba, West Covina, CA (US)

(73) Assignee: MJT HOLDINGS, LLC, Valdosta, GA (US)

(21) Appl. No.: 14/268,984

(22) Filed: May 2, 2014

Related U.S. Application Data
(60) Provisional application No. 61/818,835, filed on May 2, 2013.

(51) Int. Cl. B66C 1/66

(52) U.S. Cl. CPC B66C 1/66
USPC 294/215

(57) ABSTRACT

In an omni-positional hoist ring assembly, a U-bar is pivotally mounted to a body, and a mounting member is threadably mountable to a load. The body is mounted to swivel about the mounting member, and includes a detent engaging bore. The mounting member includes a threaded stud or threaded female connector, and a head engagable by a torque-applying tool. A latching assembly is adapted to axially releasably retain the body to the mounting member, and includes a detent and a C-washer. The C-washer is pivotally mounted to the body and has a threaded detent retaining bore. The detent has a male detent thread engaged with the threaded detent retaining bore for holding the detent in engagement with the C-washer. The detent includes a plunger which is spring biased to reversibly urge a body engaging member into engagement with the detent engaging bore.

### RELATED APPLICATIONS

This application claims the benefit of U.S. Provisional Application No. 61/818,835 filed May 2, 2013, the contents of which are incorporated by this reference in their entirety for all purposes as if fully set forth herein.

### TECHNICAL FIELD

The present invention relates generally to the field of hoist ring assemblies. More particularly, the invention concerns hoist ring assemblies capable of safe and rapid connection and disconnection from an object subject to a lifting operation.

### BACKGROUND

Omni-positional hoist ring assemblies are critical safety devices that allow loads or forces to be safely applied from any direction. Contributing to the versatility of such omni-positional hoist ring assemblies is the ability of the lifting loop or U-bar member to rotate about the longitudinal axis of the hoist ring through 360 degrees while simultaneously pivoting through a perpendicular arc of approximately 180 degrees. Such hoist ring assemblies thus automatically align themselves with the direction of any force that is applied to them within a hemisphere that approximately surrounds the hoist ring. See, for example, Tsui U.S. Pat. No. 5,848,815, which is hereby incorporated herein by reference as though fully set forth hereat. Omni-positional hoist ring assemblies are typically employed by being firmly mounted to an object that is to be hoisted or otherwise moved. A crane or other device is then attached to the Omni-positional hoist ring assembly, and a hoisting or other moving force or load is applied by the crane to the U-bar member of the hoist ring, which results in the desired moving of the object. An omni-positional hoist ring assembly should be capable of bearing approximately five times the force or load that is required to move the object. It should be designed and mounted so as to safely handle such an excess force should circumstances inadvertently impose it during a moving operation. The elements by which such a hoist ring assembly is mounted to an object must reliably and safely withstand such excess force. Such hoist rings should be carefully installed. Typically, such installation involves applying a specified amount of torque to a mounting screw, or welding the hoist ring to an object that is to be hoisted or otherwise moved. This torque is typically measured, and requires a certain amount of skill to apply properly. For reasons of safety and convenience, general purpose hoist rings are generally not removed from the objects to which they are attached except for maintenance. Some hoist rings that are designed for special applications, such as road plate lifting, do involve specially designed hoist rings that are detached after use. Some hoist rings are designed to be welded to an object, which significantly limits their removability unless special mounting elements are employed. See, for example, Alba U.S. Pat. No. 6,953,212, which is hereby incorporated herein by reference as though fully set forth hereat.

There is a need for an omni-positional hoist ring assembly that can be installed in a conventional manner with a properly torqued threaded connection, and safely and quickly connected and disconnected from an object by unskilled workers.

### SUMMARY

An omni-positional hoist ring assembly may preferably comprise a U-bar member, a body member, a mounting member and a latching assembly. The U-bar member is pivotally mounted to a body member. The mounting member is adapted to being threadably mounted to an object intended to be lifted by the hoist ring assembly. The body member is mounted to the mounting member for swiveling motion about the mounting member. The body member includes a detent engaging bore formed therein. The mounting member may typically include a threaded stud portion, a head element adapted to be engaged by a torque-applying tool, a latching groove, a generally cylindrical journal and a bearing flange element.

The latching assembly is adapted to axially releasably retain the body member to the mounting member. The latching assembly comprises a detent member and a C-washer element. The C-washer is pivotally mounted to the body through a pivot pin and has a threaded detent retaining bore. The detent member has a male detent thread thereon. The male detent thread is adapted to threadably engage with the threaded detent member retaining bore and hold the detent member in operable engagement with the C-washer. The detent member preferably includes a plunger element which is spring biased to urge the body engaging member into engagement with the detent engaging bore. The spring bias is adapted to being overcome by application of an axial pulling force on the plunger element, thereby substantially removing the body engaging member from engagement with the detent engaging bore.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic exploded view of one example embodiment of an omni-positional hoist ring assembly in accordance with the present invention;

FIG. 2 is a diagrammatic view of the embodiment of FIG. 1, but shown in an assembled configuration;

FIG. 3 is a diagrammatic view of another example embodiment of the present invention, wherein rather than a threaded stud portion being an integral part of the hoist ring assembly, a threaded axial bore is provided to receive a threaded stud mounted in the object to be lifted using the hoist ring assembly;

FIG. 4 is a diagrammatic front elevational view of the embodiment of FIG. 1;

FIG. 5 is a diagrammatic perspective view of the embodiment of FIG. 1;

FIG. 6 is a diagrammatic side elevation view of one example embodiment of a mounting member in accordance with the present invention;

FIG. 7 is a diagrammatic top plan view of the mounting member of FIG. 6;

FIG. 8 is a diagrammatic to plan view of one example embodiment of a C-washer element in accordance with the present invention;

FIG. 9 is a diagrammatic side elevational view of the C-washer element of FIG. 8; and

FIG. 10 is a diagrammatic perspective view of the C-washer element of FIG. 8.

### DETAILED DESCRIPTION OF THE PREFERRED EMBODIMENTS

According to the present invention, an omni-positional hoist ring assembly is provided, wherein a pivot-swivel assembly is threadably mounted to an object through a mounting member, and a latching assembly releasably retains this hoist ring assembly together.

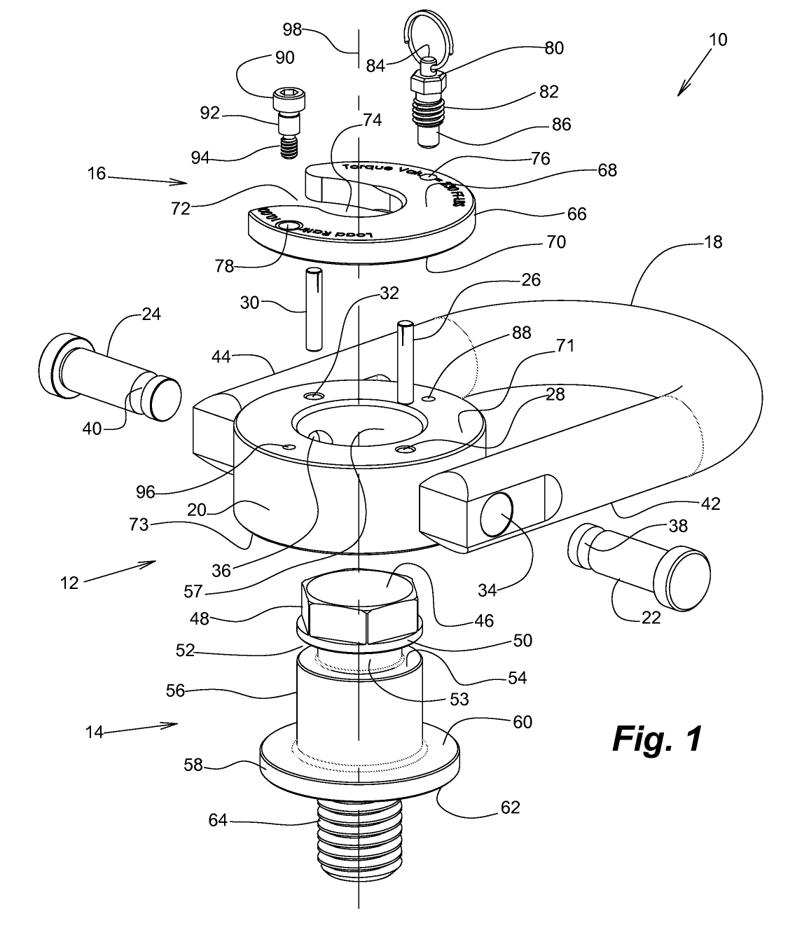

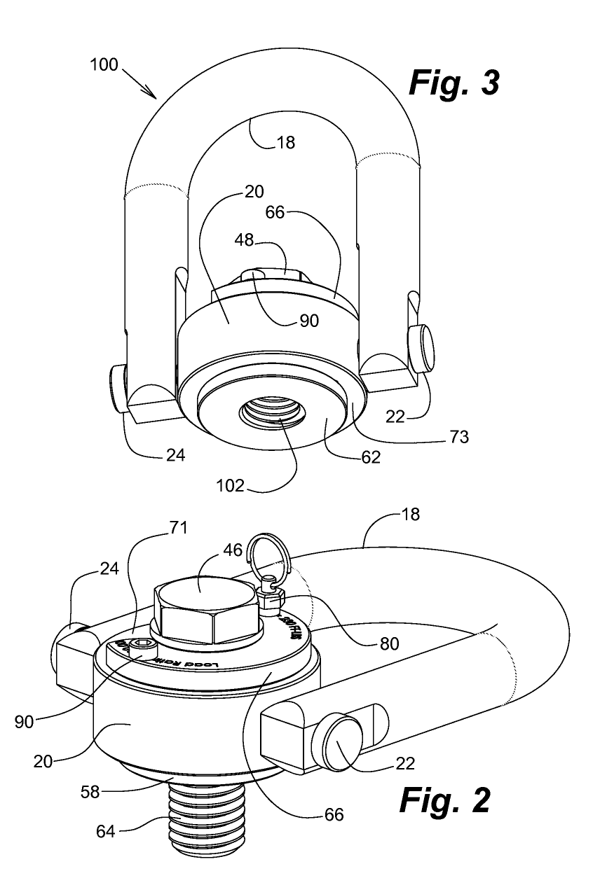

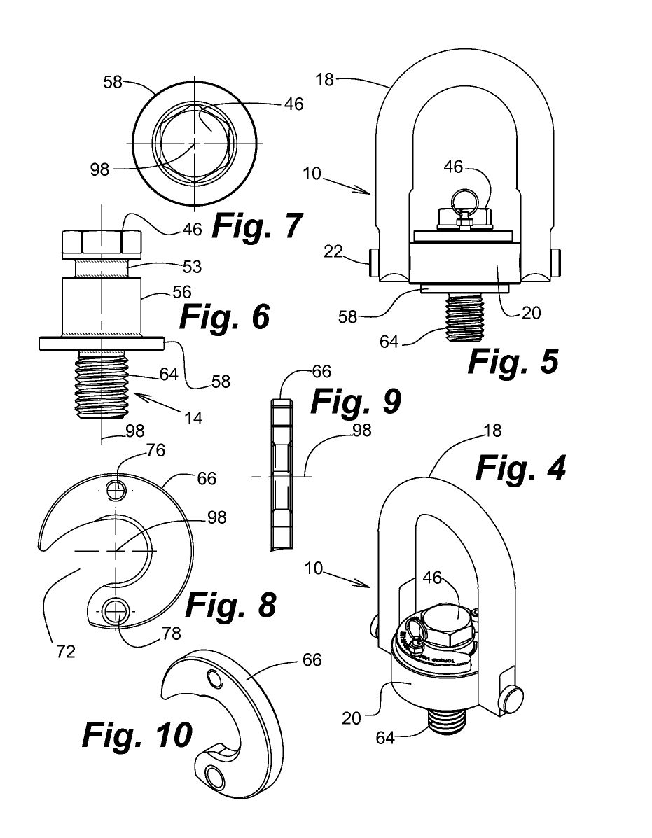

An embodiment 10 of the present omni-positional hoist ring assembly, which has been chosen for purposes of illustration, is shown in exploded view in FIG. 1, and in fully assembled views in FIGS. 2, 4 and 5. A further embodiment 100 is shown in FIG. 3, wherein a female mountable omni-positional hoist ring assembly is intended to be attached to an object through a female threaded connection. An embodiment 14 of a mounting member in the form of a one-piece member that includes a threaded stud portion, a hex-head element, a latching groove, a generally cylindrical journal, and a bearing flange element is shown in detail FIGS. 1, 6, and 7. An embodiment 16 of a latching assembly in the form of a C-washer and associated elements is shown in FIGS. 1, 8, 9, and 10.

Referring particularly to FIGS. 1 through 5, an embodiment 12 of a pivot-swivel assembly includes a lifting loop in the form of U-bar member 18. U-bar member 18 is pivotally mounted to body member 20 by first and second pin elements 22 and 24, respectively. First and second pin elements 22 and 24 are aligned along a common axis so that when it is mounted to them, U-bar member 18 is journaled on and free to pivot around such pin elements. First U-bar leg 42 is adapted to being rotatably journaled on first pin element 22 by way of bearing bore 34. Similarly, second U-bar leg 44 is adapted to being rotatably journaled on second pin element 24 by way of a second bearing bore, not shown.

In this embodiment, the respective pin elements 22 and 24 extend through the bearing bores in U-bar legs 42 and 44, respectively, and into mating body bearing bores of which only body bearing bore 36 is shown. Pin elements 22 and 24 are retained in the mating body bores by engagement with first and second retainer elements 26 and 30, respectively. First and second retainer elements 26 and 30, in certain embodiments, are roll pins. These retainer elements 26 and 30 are approximately the length of the thickness of body 20, so they do not interfere with the movement of body 20. Retainer elements 26 and 30 are engaged with body 20 through first and second retainer bores 28 and 32, respectively. First retainer bore 28 intersects a bearing bore in body 20 (not shown) at a location that coincides with the position of first retainer groove 38 when first pin element 22 is fully inserted through first bearing bore 34 in first U-bar leg 42, and into such bearing bore. The insertion of first retainer element 26 into first retainer bore 28 thus retains first pin element 22 in operative engagement with first U-bar leg 42 and body 20. When so operatively engaged, first pin element 22 retains first U-bar leg and body 20 together in a functional assembly for the intended purposes of the omni-positional hoist ring assembly embodiment 10. When operatively assembled, second pin element 24, which includes second retainer groove 40, serves to similarly retain second U-bar leg 44 and body 20 in such a functional assembly.

Mounting member embodiment 14 is, in this embodiment, a solid one-piece member that serves to secure embodiment 10 of an omni-positional hoist ring assembly to an object that is to be hoisted or otherwise moved. The mounting member embodiment chosen for illustration includes hex-head element 48, latching groove 52, generally cylindrical journal 56, bearing flange element 58, and threaded stud portion 64. Hex-head element 48 is located adjacent proximal end 46, and threaded stud portion 64 is located adjacent the proximal end of this mounting member embodiment 14. Latching groove 52 is located between and defined by spaced apart first flange element 50, second flange element 54, and latching cylinder 53. Latching cylinder 53 extends between first flange element 50 and second flange element 54, and defines the bottom of latching groove 52. The diameter of latching cylinder 53 is reduced as compared to generally cylindrical journal 56. Body 20 has a generally axial bore extending therethrough to define a body bearing surface 57. Body 20 is journaled to mounting member embodiment 14 through the engagement of body bearing surface 57 on generally cylindrical journal 56. Generally cylindrical journal 56 is slightly longer than the thickness of body 20, so that body 20 is free to rotate about journal 56. Bearing distal surface 62 is adapted to compressively engage the surface of an object to which mounting member embodiment 14 is threadably attached. Hex-head element 48 is adapted to be engaged by a torque applying tool, by means of which the proper amount of torque is applied to mounting member embodiment 14. This forces bearing distal surface 62 to bear forcibly against the surface of an object to which mounting member embodiment 14 may be attached.

Latching assembly embodiment 16 in this embodiment comprises a C-washer element 66. C-washer element 66 has C-washer proximal surface 68, C-washer distal surface 70, C-washer throat 72, and C-washer central opening 74. A threaded detent member retaining bore 76 is adapted to threadably receiving detent member 80. Male detent thread 82 on detent member 80 is adapted to threadably engage with threaded detent member retaining bore 76, and hold detent member 80 in operable engagement with C-washer element 66. Plunger element 84 is spring biased to urge body engaging member 86 into engagement with detent engaging bore 88. Detent engaging bore 88 is formed in body 20. A pivot bearing 78 is formed in C-washer element 66, so as to rotatably receive journal 92. Journal 92 is formed by the shank of pivot pin 90. Pivot pin 90 includes a threaded pin portion 94 that is adapted to be received in in threaded pin receiving bore 96. Threaded pin receiving bore 96 is formed in body 20.

With particular reference to FIG. 3, an embodiment 100 of an omni-positional host ring assembly is shown. The mounting member embodiment included in embodiment 100 includes an axial bore that bears a female thread 102. Female thread 102 is adapted to engage a threaded stud. The threaded stud may, for example, be permanently mounted to an object, or it may be a bolt that passes through the structure of an object.

When body engaging member 86 is releasably received in detent engaging bore 88, journal 92 is rotatably received in pivot bearing 78, and threaded pin portion 94 is threadably received in threaded pin receiving bore 96, C-washer central opening 74 is secured in a generally concentric alignment with body bearing surface 57. This is a latched configuration. In this latched configuration, C-washer central opening 74, body bearing surface 57, and embodiment 14 of the mounting member are generally concentric with longitudinal axis 98 of embodiment 10. When body engaging member 86 is disengaged from detent engaging bore 88, C-washer element 66 is free to pivot around journal 92, so long as its pivotal motion is not blocked by U-bar member 18. In this configuration C-washer distal surface 70 is adjacent obverse face 71 of body 20, and bearing flange proximal surface 60 is adjacent reverse face 73 of body 20.

Embodiment 10 of an omni-positional hoist ring is adapted to be attached to an object that is intended to be moved. Mounting member embodiment 14 is threadably secured to a load through a male or female connection, and torqued to the proper level of tension. Pivot-swivel embodiment 12 and latching assembly embodiment 16 are assembled together with U-bar member 18 and body 20 pinned together for pivotal movement about first and second pin elements 22 and 24. C-washer element 66 is pivotally mounted to body 20 through pivot pin 90. C-washer element 66 is pivoted to an unlatched configuration where C-washer central opening 74 is out of alignment with body retaining surface 57, and is not occluding any part of the axial bore that forms body retaining surface 57. The axial bore in body 20 is then slipped over generally cylindrical journal 56, and C-washer 66 is pivoted to a latched configuration where the surface that defines C-washer central opening 74 is seated in latching groove 52 adjacent latching cylinder 53. The location of pivot pin 90 is such that as C-washer 66 pivots between unlatched and latched configurations, latching cylinder 53 passes through C-washer throat 72. Pivot pin 90 is also positioned so that when C-washer central opening 74 is engaged in a latching configuration with latching groove 52, C-washer central opening 74 is generally concentric with longitudinal axis 98. Body bearing surface 57, latching cylinder 53, generally cylindrical journal 56, bearing flange element 58, and threaded stud portion 64 are also generally concentric with longitudinal axis 98. The latching engagement between C-washer element 66 and latching groove 52 prevents body 20 from moving axially out of engagement with generally cylindrical journal 56. As pivot-swivel assembly embodiment 12 swivels about longitudinal axis 98, latching assembly embodiment 16 is carried by and pivots with it. Mounting member embodiment 14 does not move in any direction relative to the object to which it is threadably mounted.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An omni-positional hoist ring assembly comprising:
a U-bar member pivotally mounted to a body member;
a mounting member adapted to being threadably mounted to an object, said body member being mounted to said mounting member for swiveling motion about said mounting member; and
a latching assembly adapted to releasably retain said body member to said mounting member.

2. An omni-positional hoist ring assembly of claim 1, wherein said mounting member includes a threaded male stud.

3. An omni-positional hoist ring assembly of claim 1, wherein said mounting member includes a threaded female connection.

4. An omni-positional hoist ring assembly of claim 1, wherein:
said mounting member includes a threaded stud portion, a head element adapted to be engaged by a torque-applying tool, a latching groove, a generally cylindrical journal and a bearing flange element.

5. An omni-positional hoist ring assembly of claim 1, wherein:
said mounting member includes a head element adapted to be engaged by a torque-applying tool, a threaded female connection disposed oppositely thereof, a latching groove, a generally cylindrical journal and a bearing flange element.

6. An omni-positional hoist ring assembly of claim 5, wherein:
said threaded female connection is engaged with a threaded stud protruding from an object to be lifted by way of said hoist ring assembly.

7. An omni-positional hoist ring assembly of claim 6, wherein said threaded stud is permanently mounted to said object.

8. An omni-positional hoist ring assembly of claim 6, wherein said threaded stud is a portion of a bolt passing through the structure of said object.

9. An omni-positional hoist ring assembly of claim 1, wherein:
said latching assembly comprises a detent member and a C-washer element, said C-washer being pivotally mounted to said body through a pivot pin and having a threaded detent retaining bore, said detent member having a male detent thread thereon, said male detent thread being adapted to threadably engage with said threaded detent member retaining bore and hold said detent member in operable engagement with said C-washer.

10. An omni-positional hoist ring assembly of claim 9, wherein:
said body member incudes a detent engaging bore formed therein; and
said detent member includes a plunger element which is spring biased to urge said body engaging member into engagement with said detent engaging bore.

11. An omni-positional hoist ring assembly of claim 10, wherein said spring bias is adapted to being overcome by application of an axial pulling force on said plunger element, thereby substantially removing said body engaging member from engagement with said detent engaging bore.

12. An omni-positional hoist ring assembly comprising:
a U-bar member pivotally mounted to a body member;
a mounting member adapted to being threadably mounted to an object, said body member being mounted to said mounting member for swiveling motion about said mounting member, said body member including a detent engaging bore formed therein, said mounting member including a threaded stud portion, a head element adapted to be engaged by a torque-applying tool, a latching groove, a generally cylindrical journal and a bearing flange element; and
a latching assembly adapted to releasably retain said body member to said mounting member, said latching assembly comprising a detent member and a C-washer element, said C-washer being pivotally mounted to said body through a pivot pin and having a threaded detent retaining bore, said detent member having a male detent thread thereon, said male detent thread being adapted to threadably engage with said threaded detent member retaining bore and hold said detent member in operable engagement with said C-washer, said detent member including a plunger element which is spring biased to urge said body engaging member into engagement with said detent engaging bore;
wherein said spring bias is adapted to being overcome by application of an axial pulling force on said plunger element, thereby substantially removing said body engaging member from engagement with said detent engaging bore.
